(19) United States
(12) Patent Application Publication
(10) Pub. No.: US 2014/0326068 A1
(43) Pub. Date: Nov. 6, 2014

(54) Measuring Cup for Watering Potted Plant

(71) Applicant: Po-Jen Lee, Luzhu Township (TW)

(72) Inventor: Po-Jen Lee, Luzhu Township (TW)

(21) Appl. No.: 13/874,524

(22) Filed: May 1, 2013

(51) Int. Cl. G01F 19/00

(52) U.S. Cl. CPC G01F 19/00
USPC 73/427

(57) ABSTRACT

A measuring cup for watering a potted plant contains a watering scale formed thereon and a comparison table arranged thereon, wherein the comparison table has a size scale and indicated words shown thereon, wherein the indicated words are every 7 days. The potted plant is a potted phalaenopsis. A size range of the size scale is 2 to 6 inch. The indicated words means a separated watering time is 7 days. The watering scale means a watering amount range is 50 ml to 300 ml.

### FIELD OF THE INVENTION

The present invention relates to a measuring cup which is used to water a potted plant at a predetermined water amount within a certain period time.

### BACKGROUND OF THE INVENTION

Phalaenopsis grows in a warm and wet condition, for example, a suitable growing temperature is 25° C. to 30° C. (i.e., 57° F. to 62° F.), and a growing period time means a new leaf grows within 40 days to 45 days. Accordingly, if a temperature in a growing room is high and keeps in a long period of time, the leaves lose water or cannot grow flower. Also, if the temperature in the growing room lowers to 13° C. to 15° C. (i.e., 45° F. to 47° F.), the Phalaenopsis stops growing.

Therefore, a humidity of the phalaenopsis has to be kept at 60% to 85% so as to grow the phalaenopsis well. However, consumers cannot water the phalaenopsis at a certain water amount or in a suitable period of time.

The present invention has arisen to mitigate and/or obviate the afore-described disadvantages.

### SUMMARY OF THE INVENTION

The primary object of the present invention is to provide a measuring cup which is used to water a potted plant at a predetermined water amount within a certain period time.

To obtain the above objectives, measuring cup for watering a potted plant contains a watering scale formed thereon and a comparison table arranged thereon, wherein the comparison table has a size scale and indicated words shown thereon, wherein the indicated words are every 7 days. The potted plant is a potted phalaenopsis. A size range of the size scale is 2 to 6 inch. The indicated words means a separated watering time is 7 days. The watering scale means a watering amount range is 50 ml to 300 ml.

### BRIEF DESCRIPTION OF THE DRAWINGS

FIG. 1 is a perspective view showing the assembly of a measuring cup for watering a potted plant according to the present invention.

FIG. 2 is a plan view showing the assembly of the measuring cup for watering the potted plant according to the present invention.

FIG. 3 is a plan view showing the operation of the measuring cup for watering the potted phalaenopsis according to the present invention.

FIG. 4 is another plan view showing the operation of the measuring cup for watering the potted phalaenopsis according to the present invention.

FIG. 5 is also plan view showing the operation of the measuring cup for watering the potted phalaenopsis according to the present invention.

### DETAILED DESCRIPTION OF THE PREFERRED EMBODIMENTS

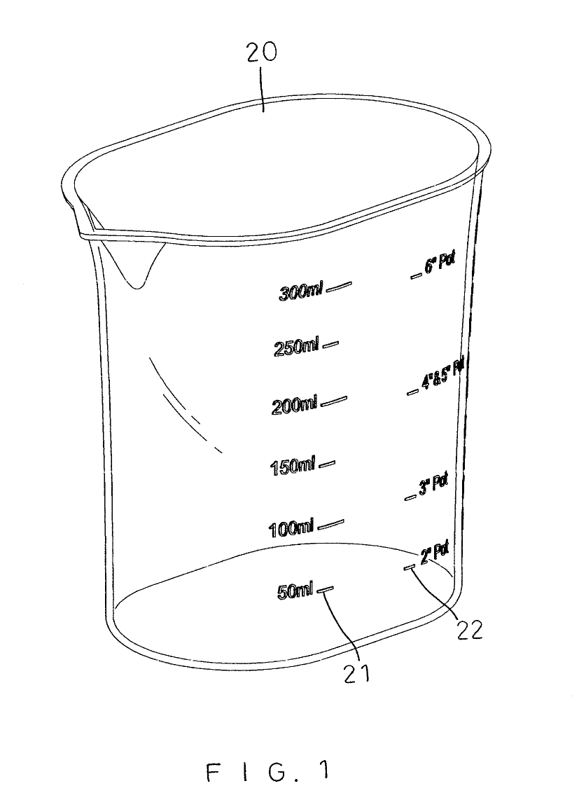

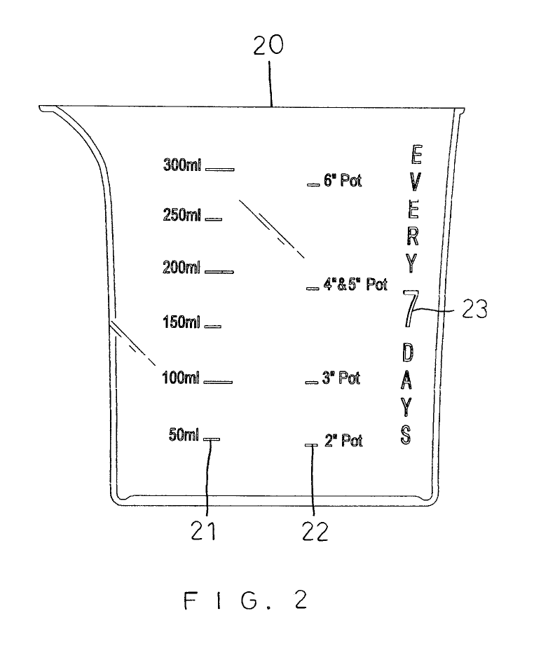

FIG. 1 is a perspective view showing the assembly of a measuring cup for watering a potted plant according to the present invention. FIG. 2 is a plan view showing the assembly of the measuring cup for watering the potted plant according to the present invention. A measuring cup 20 of the present invention is used to water a potted plant, i.e., a potted phalaenopsis 10 and includes a watering scale 21 formed thereon and a comparison table arranged thereon, wherein the comparison table has a size scale 22 and indicated words 23 (i.e., every 7 days) shown thereon, wherein a size range of the size scale 22 is 2 to 6 inch, the indicated words 23 (i.e., every 7 days) means a separated watering time is 7 days, and the watering scale 21 shows a watering amount range is 50 ml to 300 ml.

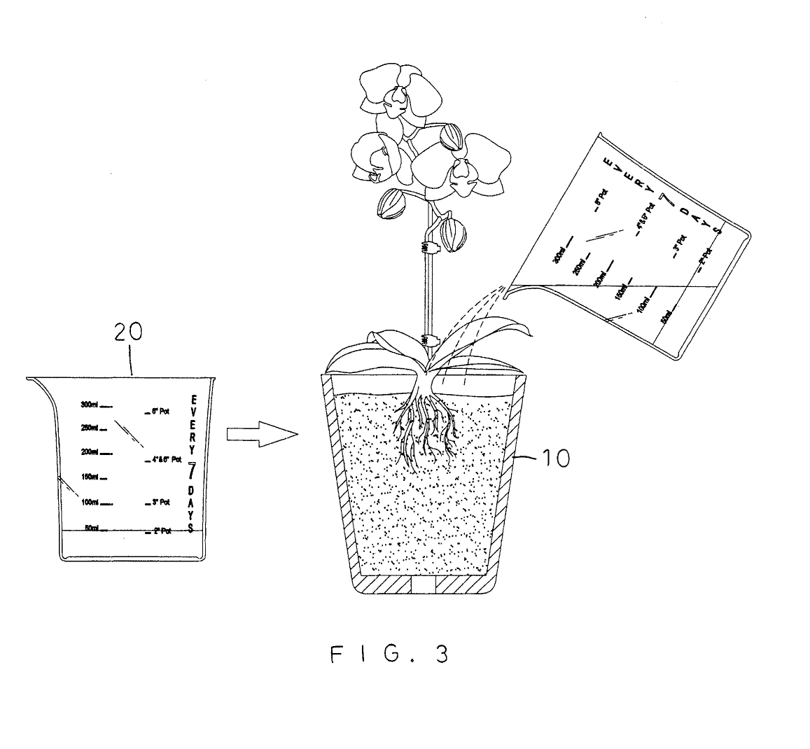

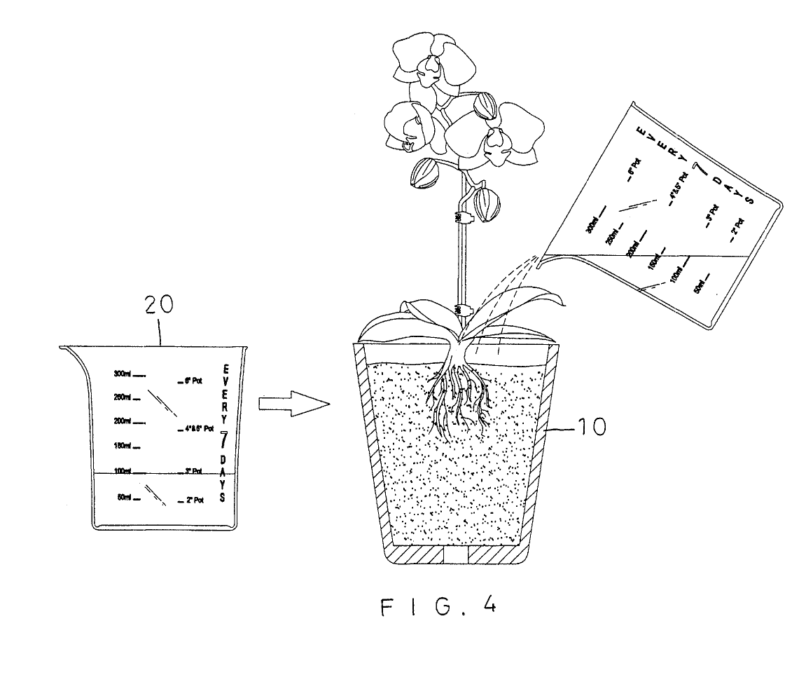

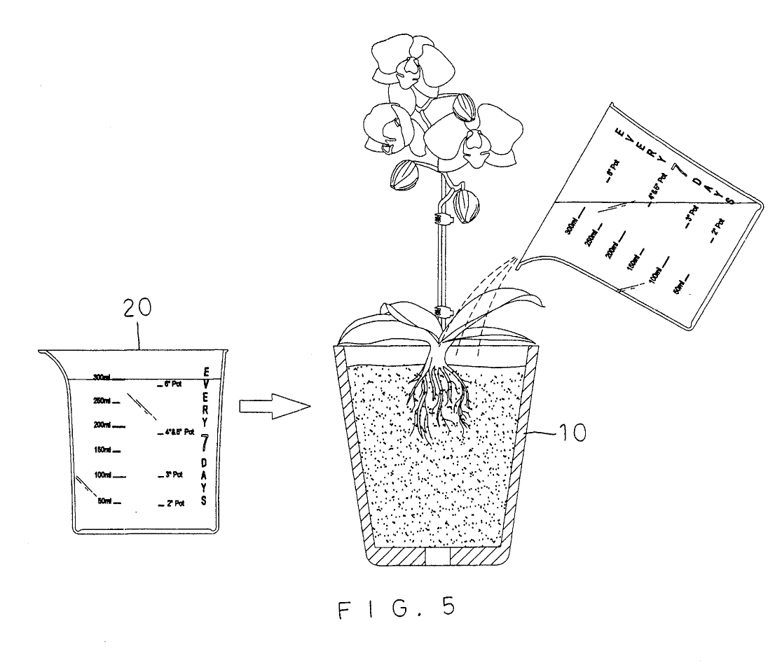

FIGS. 3-5 are a plan view showing the operation of the measuring cup for watering the potted phalaenopsis according to the present invention. Accordingly, the measuring cup is used to water 2-inch potted phalaenopsis as shown in FIG. 3, the watering cup is applied to water 3-inch potted phalaenopsis as shown in FIG. 4, and the watering cup is served to water 6-inch potted phalaenopsis as shown in FIG. 5.

After purchasing the potted phalaenopsis 10, a user compares a size of the potted phalaenopsis 10 with the comparison table of the measuring cup 20 and learns that the potted phalaenopsis 10 has to be watered every 7 days, thereafter the measuring cup 20 is used to hold water at 50 ml so as to water a 2-inch potted phalaenopsis 10, at 100 ml so as to water 3-inch potted phalaenopsis 10, or at 300 ml so as to water 6-inch potted phalaenopsis 10. Thereby, the potted phalaenopsis 10 with a varying size grows well after being watered required water amount.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A measuring cup for watering a potted plant comprising:
a watering scale formed thereon and a comparison table arranged thereon, wherein the comparison table has a size scale and indicated words shown thereon, wherein the indicated words are every 7 days.

2. The measuring cup for watering the potted plant as claimed in claim 1, wherein the potted plant is a potted phalaenopsis.

3. The measuring cup for watering the potted plant as claimed in claim 1, wherein a size range of the size scale is 2 to 6 inch.

4. The measuring cup for watering the potted plant as claimed in claim 1, wherein the indicated words means a separated watering time is 7 days.

5. The measuring cup for watering the potted plant as claimed in claim 1, wherein the watering scale shows a watering amount range is 50 ml to 300 ml.
